(19) United States
(12) Patent Application Publication
(10) Pub. No.: US 2022/0383239 A1
(43) Pub. Date: Dec. 1, 2022

(54) LOGISTICS CONTROL SYSTEM AND METHOD

(71) Applicant: Hyunsung Co., Ltd., Busan (KR)

(72) Inventors: BYUNG KANG PARK, Anyang-si (KR); HANG SEOK CHOI, Seongnam-si (KR)

(73) Assignee: Hyunsung Co., Ltd., Busan (KR)

(21) Appl. No.: 17/828,040

(22) Filed: May 31, 2022

(30) Foreign Application Priority Data
May 31, 2021 (KR) 10-2021-0069824

(51) Int. Cl. G06Q 10/08; G01S 5/02; G01S 19/47

(52) U.S. Cl. CPC G06Q 10/083; G01S 5/0221; G01S 19/47

(57) ABSTRACT

A logistics control system includes a server configured to receive information on signal strengths of the signal, which is transmitted from the logistics device, from the at least three base station, specify a departure area of the logistics device using at least three signal strengths, specify a first travel area to which the logistics device is moved using azimuth and travel distance information received from the logistics device on the basis of the departure area after a certain time elapses, specify a second travel area to which the logistics device is moved using at least three signal strengths, and specify a presence area where the first travel area and the second travel area overlap as a location to which the logistics device is moved.

### BACKGROUND

### Field of the Invention

The present invention relates to a logistics control system and method for detecting a location of a logistics device which is carried together with freight.

### Discussion of Related Art

Logistics has been put in place since the beginning of human economic activity. However, logistics has started attracting attention because companies are currently required to streamline the flow of goods accurately and quickly from the supply of raw materials to the delivery of finished products with the market's consumer-centric shift and the activation of e-commerce.

Logistics activities have started from derivative demands of economic activities that simply handle freight, such as transportation, storage, loading and unloading, and packaging, etc., and are in the limelight as a means of improving the efficiency of the overall industry with the development of global supply chain management techniques.

In the field of logistics, consignors and logistics companies aim for the common goal of reducing logistics costs, and thus in the development of a new logistics technology, it is necessary to achieve higher performance and strengthen linkages with more active and creative ideas.

Also, logistics technologies correspond to a complex application technology field in which logistics security, safety, and eco-friendly issues as well as a reduction in logistics costs should be taken into consideration.

The core of a logistics system and logistics process is to flexibly link freight, information, and money flow in the entire logistics process.

Therefore, logistics facilities, equipment, software technology, etc. required to achieve three goals of technology development, which are efficiency and effectiveness, security and safety, and sustainability and environmental benefit, in each process of transportation, storage, loading and unloading, packaging, etc. correspond to logistics technologies.

Currently, fundamental logistics infrastructure and equipment for logistics rationalization and logistics technologies for more efficient running are under development.

The industrial environment is rapidly changing due to constant technological development, introduction of new management techniques, etc. for holding a dominant position in the fierce competition of the global market. In such a change, the logistics industry, which is attracting attention as the core of competitiveness of the manufacturing industry, is also developing with technology development that is different from the concept in the past.

The logistics technology may be divided into company-based logistics technology and public sector logistics technology. The company-based logistics technology may be divided into a logistics running and solution field and a logistics infrastructure and facility field, and the public sector logistics technology corresponds to main means of logistics transportation such as railroad, road, sea, and air transportation.

Recent logistics environments have made for small amounts of goods, light and thin goods, and frequent deliveries due to demands of various customers, and it is necessary to cope with social changes such as lack of manpower, avoidance of physical work, increasing interest in environmental issues, etc.

These changes require the diversity and rapidity of service and the efficiency of management and running in the logistics industry.

In order for the logistics industry to appropriately meet these demands, it is necessary to flexibly manage information and money flow in a logistics system and an entire logistics process, and it is most important to link and integrate means and functions with each other in real time. Accordingly, development is underway on a system management and solution field for integrating and adjusting logistics processes over the entire supply chain.

Meanwhile, security is very important in the logistics industry. Logistics companies and the customers concern whether a person is a correct sender or whether a person is a correct receiver and are constantly concerned about damage or loss of freight in the delivery process.

### SUMMARY OF THE INVENTION

The present invention is directed to providing a logistics control system method for detecting a location of a logistics device carried together with freight.

However, the above object is exemplary, and the scope of the present invention is not limited thereto.

According to an aspect of the present invention, there is provided a logistics control system for receiving signals from at least three base stations to which a logistics device transmits a signal while carried together with freight and tracking the logistics device, the logistics control system including a server configured to receive information on signal strengths of the signal, which is transmitted from the logistics device, from the at least three base stations, specify a departure area of the logistics device using at least three signal strengths, specify a first travel area to which the logistics device is moved using azimuth and travel distance information received from the logistics device on the basis of the departure area after a certain time elapses, specify a second travel area to which the logistics device is moved using at least three signal strengths, and specify a presence area where the first travel area and the second travel area overlap as a location to which the logistics device is moved.

The server may load information on a road corresponding to any one of the first travel area, the second travel area, and an overlapping area of the first travel area and the second travel area and specify an area where the overlapping area of the first travel area and the second travel area and the road overlap as the presence area.

The server may load road information and specify an area where an area specified using the at least three signal strengths and a road overlap as the departure area.

The server may receive the azimuth and travel distance information from the logistics device including an acceleration sensor for measuring azimuth and travel distance information.

When global positioning system (GPS) information of the logistics device is not received from the logistics device, the server may specify the presence area using the azimuth and travel distance information and the signal strengths.

According to another aspect of the present invention, there is provided a logistics control method including a departure specification operation of receiving information on signal strengths of a signal, which is transmitted from a logistics device, from at least three base stations and specifying a departure area of the logistics device using at least three signal strengths, a travel area specification operation of specifying a first area to which the logistics device is moved using azimuth and travel distance information received from the logistics device on the basis of the departure area after a certain time elapses and specifying a second travel area to which the logistics device is moved using at least three signal strengths, and a presence area specification operation of specifying a presence area where the first travel area and the second travel area overlap as a location to which the logistics device is moved.

The logistics control method may further include, after the travel area specification operation, a road specification operation of loading and specifying a road corresponding to an area where the first travel area and the second travel area overlap from road information.

The presence area specification operation may include specifying an area where the overlapping area of the first travel area and the second travel area and the road overlap as the presence area.

The departure area measurement operation may include specifying an area where an area specified using the at least three signal strengths and the road overlap as the departure area.

Aspects, characteristics, and advantages other than those described above will be apparent from the following detailed description, claims, and accompanying drawings for implementing the present invention.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a conceptual diagram schematically illustrating a logistics control system according to an exemplary embodiment of the present invention;

FIG. 2 is a block diagram schematically illustrating a logistics device of a logistics control system according to the exemplary embodiment of the present invention;

FIG. 3 is a flowchart schematically illustrating a logistics control method according to the exemplary embodiment of the present invention;

FIGS. 4 to 7 are diagrams schematically illustrating the logistics control method according to the exemplary embodiment of the present invention; and

FIGS. 8 and 9 are a flowchart and conceptual diagram schematically illustrating a logistics control method according to another exemplary embodiment of the present invention.

### DETAILED DESCRIPTION OF EXEMPLARY EMBODIMENTS

Hereinafter, the present invention will be described with reference to the accompanying drawings. Various changes may be made to the present invention, and the invention may have various embodiments, particular embodiments of which will be described in detail with reference to the drawings. However, embodiments according to the concept of the present invention are not construed as being limited to the particular embodiments and include all changes and/or equivalents or substitutes that do not depart from the spirit and technical scope of the present invention. In regard to the description of the drawings, like reference numerals refer to like elements.

The term “include,” “may include,” etc. used in various embodiments of the present invention is to indicate the presence of functions, operations, elements, etc. disclosed herein and does not preclude the presence or addition of one or more functions, operations, elements, etc. In various embodiments of the present invention, the term “include,” “have,” etc. is to indicate the presence of features, numbers, steps, operations, elements, parts, or combinations thereof described in the specification and does not preclude the presence or addition of one or more other features, numbers, steps, operations, elements, parts, or combinations thereof.

In various embodiments of the present invention, the term “or” or the like includes any one and all combinations of the listed words. For example, “A or B” may include A, B, or both A and B.

While terms “first,” “second,” etc. used in various embodiments of the present invention may modify various elements of the embodiments, the elements are not limited by the terms. For example, the terms do not limit the sequence and/or importance of the elements. The terms may be used for distinguishing one element from another. For example, both a first user device and a second user device may be user devices and represent different user devices. For example, a first element may be named a second element without departing from the scope of various embodiments of the present invention, and similarly, a second element may be named a first element.

When an element is referred to as being “connected” or “coupled” to another element, it should be understood that the element may be directly connected or coupled to the other element but still another element may also be interposed therebetween. On the other hand, when an element is referred to as being “directly connected” or “directly coupled” to another element, it should be understood that there is no element therebetween.

Terms used in various embodiments of the present invention are for the purpose of describing particular embodiments only and are not intended to limit various embodiments of the present invention. The singular forms are intended to include the plural forms as well unless the context clearly indicates otherwise.

All terms used herein including technical or scientific terms have the same meanings as those generally understood by those skilled in the technical field to which various embodiments of the present invention pertain.

Terms defined in a generally used dictionary should be interpreted as having the same meanings as the contextual meanings of the relevant technology and should not be interpreted as having ideal or exaggerated meanings unless clearly defined in various embodiments of the present invention.

In the following descriptions, a system may be any one, some, or all of a configuration of devices, an operating method of the devices, a computer program for executing the operating method of the devices, and a medium on which the computer program is recorded.

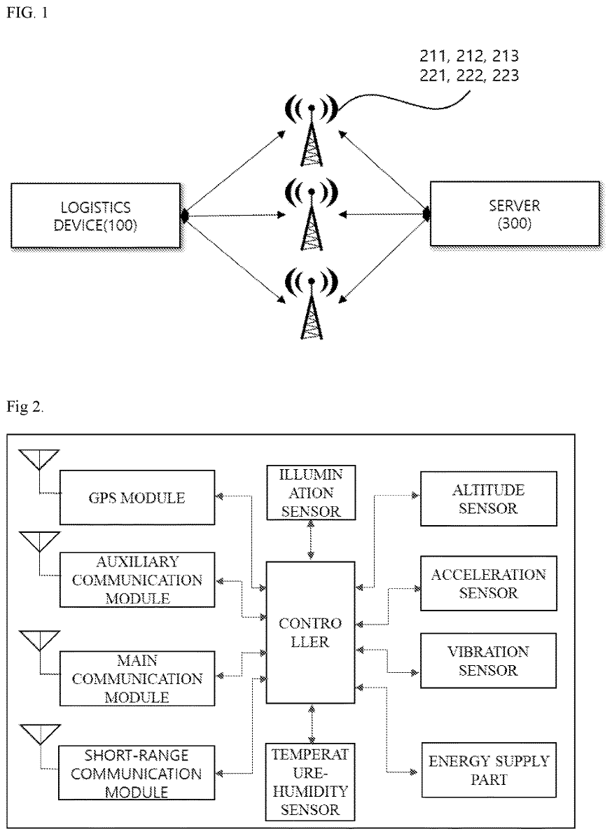

FIG. 1 is a block diagram schematically illustrating a logistics control system according to an exemplary embodiment of the present invention. The logistics control system according to the exemplary embodiment includes a server 300. The logistics control system may additionally include a logistics device 100 which is moved together with freight. The logistics device 100 and the server 300 may communicate through at least three base stations 211, 212, and 213 or 221, 222, and 223.

The logistics device 100 may detect various states including location information and transmit all or some of the detected information to the server 300.

The server 300 may receive information from the logistics device 100 through a communication network and estimate the location of the logistics device 100 or determine a state of freight. The server 300 may provide such information to a person concerned. The server 300 includes CPU, RAM, storage, etc.

Meanwhile, the server 300 and the logistics device 100 are connected through a network, in particular, the at least three base stations 211, 212, and 213 or 221, 222, and 223. In this case, the server 300 and the logistics device 100 may be connected through a low power wide area (LPWA) network. More specifically, the server 300 and the logistics device 100 may be connected through at least one of Sigfox, Lora, Long Term Evolution for Machines (LTE-M), narrowband Internet of things (NB-IoT), etc. However, the connection is not limited thereto.

The at least three base stations 211, 212, and 213 or 221, 222, and 223 may be present between the server 300 and the logistics device 100 to connect the server 300 and the logistics device 100 so that the server 300 and the logistics device 100 transmit and receive signals.

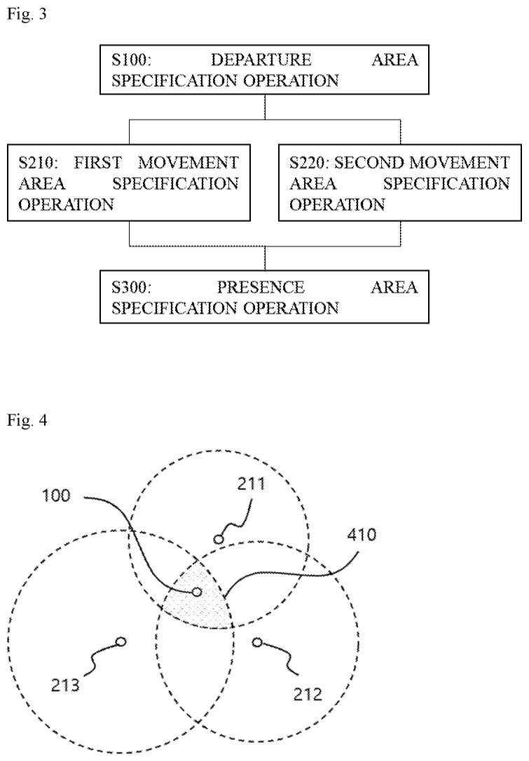

FIG. 2 is a block diagram schematically illustrating the logistics device 100. The logistics device 100 according to the exemplary embodiment is moved together with freight by at least one of sea, air, and land. For example, the logistics device 100 may be moved by land from a storehouse to an airport or port and moved by ship or plane and then may arrive at the destination by land again. In other words, the logistics device 100 may be transported in a multiple way.

The logistics device 100 may be moved together with freight, detect surrounding information, and determine a state of the freight or an external state on the basis of the surrounding information. Also, the logistics device 100 may transmit some or all of the detected information to the server 300.

The logistics device 100 includes an acceleration sensor, a main communication module, a controller, and an energy supply part. More specifically, the logistics device 100 includes a 6-axis acceleration sensor, the main communication module including a LPWA module, a controller which is in charge of overall control of the logistics device 100 and includes a micro-control unit (MCU), and the energy supply part which supplies electric power to each element of the logistics device 100.

Additionally, the logistics device 100 includes a global positioning system (GPS) module, an altitude sensor, a vibration sensor, an illumination sensor, and a temperature-humidity sensor.

Further, the logistics device 100 may include an auxiliary communication module. The auxiliary communication module may selectively include a mobile communication module, such as LTE or the like, and a short-range communication module such as WiFi, Bluetooth, etc.

However, the present invention is not limited thereto, and the logistics device 100 may selectively include the above-described elements.

The acceleration sensor may measure an acceleration and angular acceleration of the logistics device 100 and transmit information on the acceleration and angular acceleration to the controller. For example, the acceleration sensor may include a 6-axis acceleration sensor to measure the angular acceleration and acceleration. Alternatively, the acceleration sensor may include a 3-axis acceleration sensor and a gyro sensor to measure the acceleration and angular acceleration.

The main communication module may include an LPWA module such as Sigfox, Lora, LTE-M, NB-IoT, etc.

The GPS module may measure a current location using signals of satellites. The altitude sensor may measure a current altitude. The vibration sensor may measure vibrations applied to the logistics device 100 and/or freight.

The illumination sensor may measure ambient illuminance. In particular, when attached to freight, the illumination sensor receives no light or weak light, and when separated from the freight, the illumination sensor receives light. Accordingly, the illumination sensor may be used to determine whether freight is stolen.

The temperature-humidity sensor may measure a temperature and humidity around the logistics device 100.

The auxiliary communication module is a mobile communication module, such as LTE or the like, and may communicate with the server 300 instead of the main communication module or to assist the main communication module.

An indoor positioning module is a short-range communication module, such as WiFi, Bluetooth, etc., and may be used for tracking the indoor location of the logistics device 100.

Meanwhile, the energy supply part supplies electric power to each element of the logistics device 100. The energy supply part includes an energy harvesting module. More specifically, the energy harvesting module may be a vibration energy harvesting module that generates electricity from vibrations.

Since the logistics device 100 is moved together with freight, vibrations occur during the movement. Accordingly, the vibration energy harvesting module may generate power required to drive the logistics device 100 during the movement. The vibration energy harvesting module may include a piezo which generates power using vibrations, a rectifier which rectifies the generated power, and a super capacitor which stores electric energy.

Initially, the logistics device 100 is charged by an external power source. During the movement, power is generated by the vibration energy harvesting module such that the logistics device 100 is driven.

The logistics device 100 may transmit information detected by each element to the server 300. For example, the controller of the logistics device 100 may specify an azimuth θ and a travel distance D using the angular acceleration and acceleration measured by the acceleration sensor and transmit the azimuth θ and the travel distance D to the server 300.

Also, the controller of the logistics device 100 may receive the current altitude from the altitude sensor and transmit the current altitude to the server 300. In other words, the controller of the logistics device 100 may receive information from each element, determine a travel distance, a current situation, etc. using the received information, and continuously transmit the determination results to the server 300.

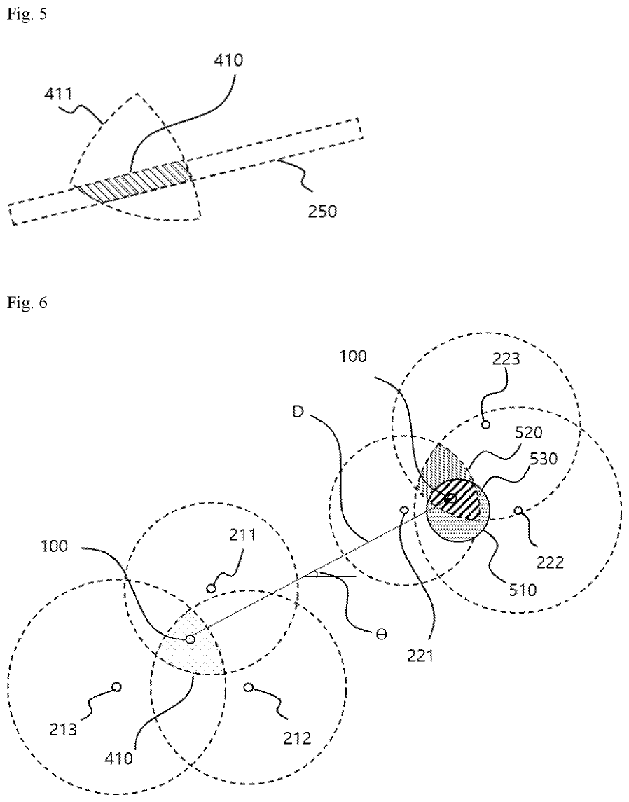

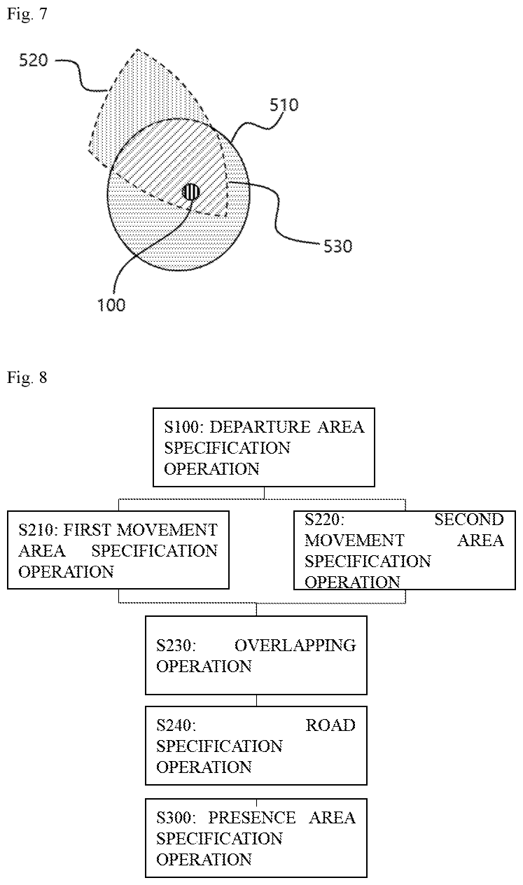

FIG. 3 is a flowchart schematically illustrating location tracking of a logistics control system and method according to the exemplary embodiment of the present invention, and FIGS. 4 to 7 are diagrams schematically illustrating location tracking for the logistics device 100. Locations of the logistics device 100 shown in FIGS. 4 to 7 are arbitrary, and the logistics device 100 may be specified as a presence area. In other words, an area described below is a presence area 530 of the logistics device 100 specified by the server 300.

To facilitate description below, the server 300 is assumed to receive signals from three base stations 211, 212, and 213 or 211, 222, and 223, but the number of base stations is not limited thereto.

Referring to FIGS. 3 and 4, a departure specification operation S100 of receiving information on signal strengths from the base stations 211, 212, and 213 to which a signal is transmitted from the logistics device 100 and specifying a departure area 410 of the logistics device 100 using the three signal strengths is performed.

In other words, the server 300 receives information on signal strengths from the three base stations 211, 212, and 213 to which a signal is transmitted from the logistics device 100 and specifies the departure area 410 of the logistics device 100 using the three signal strengths (S100).

The departure area 410 is an area that is initially specified to track the logistics device 100. After specifying the departure area 410, the server 300 may continuously specify the presence area 530 to increase accuracy.

An origin or the departure area 410 is an area specified as an initial location of the logistics device 100 and may be a departure point of the logistics device 100. However, the origin or departure area 410 is not limited thereto. Since the origin or the departure area 410 may be set again due to GPS signal interruption or the like, the origin or departure area 410 may be any area in the middle of transportation of the logistics device 100.

The server 300 may receive information on three signal strengths from the three base stations 211, 212, and 213 and specify the departure area 410 using triangulation. In other words, the server 300 may specify an area where the logistics device 100 is present as the departure area 410. A circle indicated by a dotted line surrounding each of the base stations 211, 212, and 213 is a signal strength range, and the intersection thereof may be specified as the departure area 410.

Here, a signal strength may be a received signal strength (RSS) or a received signal strength indicator (RSSI). The signal strength is the strength of a signal received by the base stations 211, 212, and 213 or 221, 222, and 223 from the logistics device 100. Each of the base stations 211, 212, and 213 serves as a relay that receives a signal from the logistics device 100 and transmits the received signal to the server 300 and may measure a signal strength of the received signal and transmit the measured signal strength to the server 300.

Referring to FIG. 5, in the departure area specification operation S100, an area where an overlapping area 411 which is specified using three signal strengths and a road 250 overlap may be specified as the departure area 410 to increase accuracy in specifying the departure area 410. The overlapping area is referred to as the “first overlapping area 411.”

Here, the server 300 may load road information and load an area of the road 250 from the road information. For example, the server 300 may store the road information therein. Alternatively, the server 300 may receive the road information from the outside and temporarily hold the road information. Otherwise, the server 300 may load information on a road corresponding to the overlapping area from the outside.

The server 300 specifies and loads the road 250 corresponding to the area 411 which is specified using the three signal strengths in the road information. The loaded road information may be a location, a name, a length, a width, etc. of the road 250. Additionally, a location and length of the road 250 corresponding to the first overlapping area 411 may be loaded as the road information.

Then, an area where the first overlapping area 411 specified using the three signal strengths and the road 250 of the departure point overlap is specified as the departure area 410. Accordingly, it is possible to accurately specify the current departure point or departure area 410 of the logistics device 100.

A system and method for specifying a location to which the logistics device 100 is moved will be described below with reference to FIGS. 3, 6, and 7 (a partial enlarged view of FIG. 6).

After a certain time elapses, a first area to which the logistics device 100 is moved is specified using the azimuth θ and the travel distance D received from the logistics device 100 on the basis of the departure area 410 (S210). Then, travel area specification operations S210 and S220 of specifying a second area to which the logistics device 100 is moved using three signal strengths are performed.

More specifically, the server 300 constantly receives information on the azimuth θ and the travel distance D from the logistics device 100 through at least one of the three base stations 221, 222, and 223 at certain time intervals. Also, the server 300 simultaneously or sequentially receives signal strengths from the three base stations 221, 222, and 223.

The server 300 performs a first travel area specification operation S210 of calculating a direction and distance that the logistics device 100 is moved from the departure area 410 using the received azimuth θ and the travel distance D and specifying a first travel area 510. There is an error in the azimuth θ and the travel distance D. Since the server 300 specifies a travel area on the basis of the departure area 410, the server 300 specifies an area to which the logistics device 100 is moved rather than an area in which the logistics device actually is present as shown in the drawing.

Meanwhile, the server 300 performs a second travel area specification operation S220 of receiving information on signal strengths from the three base stations 221, 222, and 223 and specifying a second travel area 520 to which the logistics device 100 is moved using triangulation.

The first travel area specification operation S210 and the second travel area specification operation S220 may be performed in parallel, or one of the two operations S210 and 220 may be performed first, and then the other may be performed.

In other words, in the travel area specification operations S210 and S220, two travel areas where the logistics device 100 may be present are specified.

Then, as shown in FIG. 7, a presence area specification operation S300 of specifying the presence area 530 where the first travel area 510 and the second travel area 520 overlap as a location to which the logistics device 100 is moved is performed.

The server 300 may specify an intersection of the first travel area 510 and the second travel area 520 as a current location of the logistics device 100.

In other words, the server 300 may derive two areas to which the logistics device 100 is moved using two methods and find the intersection of the two areas to accurately specify the location of the logistics device 100.

The server 300 can replace the presence area 530 with the departure area 410 and repeatedly perform the travel area specification operations S210 and S220 and the presence area specification operation S300 using the specified presence area 530 as a departure point to track the logistics device 100. In other words, the server 300 can accurately track the location every time repeating the above operations.

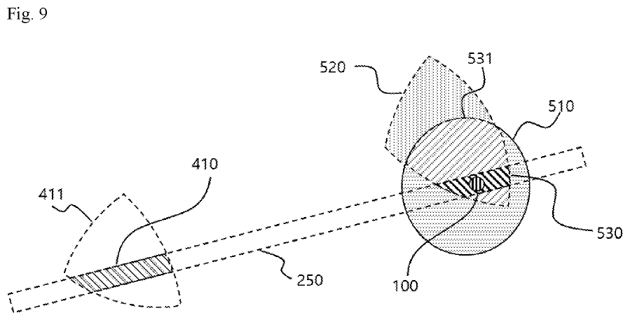

Meanwhile, FIGS. 8 and 9 are a flowchart and conceptual diagram schematically illustrating a logistics control method according to another exemplary embodiment of the present invention. In describing the present exemplary embodiment, content overlapping the above-described exemplary embodiment will be omitted.

As described above, the server 300 has road information. The server 300 may specify an area where a first travel area 510 and a road 250 overlap as a departure area 410. Alternatively, the server 300 may specify an area where a second travel area 520 and the road 250 overlap as the departure area 410. Preferably, an area where an overlapping area of the first travel area 510 and the second travel area 520 and the road 250 overlap is specified as a presence area 530. The overlapping area is referred to as a “second overlapping area 531.”

More specifically, a first travel area specification operation S210 is performed to specify the first travel area 510, and a second travel area specification operation S220 is performed to specify the second travel area 520.

Then, an overlapping operation S230 of specifying the overlapping area of the first travel area 510 and the second travel area 520 is performed.

The server 300 specifies the road 250 corresponding to the second overlapping area 531 (S240). More specifically, the server 300 extracts information on a road corresponding to the second overlapping area 531 as the road information. Here, the road information may be a location (coordinates), a name, a length, a width, etc. of the road 250. Additionally, a length of the road 250 corresponding to the second overlapping area 531 may be extracted as the road information.

In a presence area specification operation S300, the server 300 may specify the area where the second overlapping area 531 and the road 250 overlap as the presence area 530.

In this case, the road information may be additionally used in positioning the logistics device 100 on the basis of information on a signal strength, an azimuth θ, and a travel distance D such that a more accurate location can be specified.

Meanwhile, the logistics device 100 includes a GPS module. Accordingly, when the GPS module of the logistics device 100 does not work, a logistics control system may perform the above-described exemplary embodiments. However, the present invention is not limited thereto, and the logistics device 100 and freight can be tracked more accurately through positioning the GPS module in addition to the above-described exemplary embodiments.

With a logistics control system and method according to an exemplary embodiment of the present invention, a logistics device which is moved together with freight is tracked using a plurality of methods. Accordingly, it is possible to accurately track freight.

The scope of the present invention is not limited to the effect.

Although embodiments of the present invention have been described above with reference to the accompanying drawings, those skilled in the technical field to which the present invention pertains should understand that various modifications and equivalents can be made from the embodiments. Therefore, the actual technical scope of the present invention should be determined by the technical spirit of the following claims.

### Explanation of Reference

100 logistics device

211, 212, 213, 221, 222, 223 base station

300 server

410 departure area

510 first travel area

520 second travel area

530 presence area

What is claimed is:

1. A logistics control system for receiving signals from at least three base stations to which a logistics device transmits a signal while moved together with freight and tracking the logistics device, the logistics control system comprising:
a server configured to receive information on signal strengths of the signal, which is transmitted from the logistics device, from the at least three base stations;
specify a departure area of the logistics device using at least three signal strengths;
specify a first travel area to which the logistics device is moved using azimuth and travel distance information received from the logistics device on the basis of the departure area after a certain time elapses;
specify a second travel area to which the logistics device is moved using at least three signal strengths; and
specify a presence area where the first travel area and the second travel area overlap as a location to which the logistics device is moved.

2. The logistics control system of claim 1, wherein the server loads information on a road corresponding to any one of the first travel area, the second travel area, and an overlapping area of the first travel area and the second travel area and specifies an area where the overlapping area of the first travel area and the second travel area and the road overlap as the presence area.

3. The logistics control system of claim 1, wherein the server loads road information and specifies an area where an area specified using the at least three signal strengths and a road overlap as the departure area.

4. The logistics control system of claim 1, wherein the server receives the azimuth and travel distance information from the logistics device including an acceleration sensor for measuring azimuth and travel distance information.

5. The logistics control system of claim 1, wherein, when global positioning system (GPS) information of the logistics device is not received from the logistics device, the server specifies the presence area using the azimuth and travel distance information and the signal strengths.

6. The logistics control method comprising:
a departure specification operation of receiving information on signal strengths of a signal, which is transmitted from a logistics device, from at least three base stations and specifying a departure area of the logistics device using at least three signal strengths;
a travel area specification operation of specifying a first area to which the logistics device is moved using azimuth and travel distance information received from the logistics device on the basis of the departure area after a certain time elapses and specifying a second travel area to which the logistics device is moved using at least three signal strengths; and
a presence area specification operation of specifying a presence area where the first travel area and the second travel area overlap as a location to which the logistics device is moved.

7. The logistics control method of claim 6, further comprising, after the travel area specification operation, a road specification operation of loading and specifying a road corresponding to an area where the first travel area and the second travel area overlap from road information.

8. The logistics control method of claim 7, wherein the presence area specification operation comprises specifying an area where the overlapping area of the first travel area and the second travel area and the road overlap as the presence area.

9. The logistics control method of claim 6, wherein the departure area measurement operation comprises specifying an area where an area specified using the at least three signal strengths and the road overlap as the departure area.
